(19) United States
(12) Patent Application Publication
(10) Pub. No.: US 2007/0004587 A1
(43) Pub. Date: Jan. 4, 2007

(54) Method of forming metal on a substrate using a Ruthenium-based catalyst

(75) Inventors: Ramanan Chebiam, Hillsboro, OR (US); Mike Goldstein, Sunnyvale, CA (US)

Correspondence Address: FLESHNER-KIM, LLP;INTEL CORPORATION, P.O. BOX 221200, CHANTILLY, VA, 20153-1200, US

(73) Assignee: Intel Corporation

(21) Appl. No.: 11/170,160

(22) Filed: Jun. 30, 2005

(51) Int. Cl. B01J 31/00; B05D 1/18; B05D 3/00

(52) U.S. Cl. 502/167; 427/299; 427/437; 427/443.1

(57) ABSTRACT

A method of forming metal on a substrate includes forming a coupling agent with nitrogen on a substrate, forming a first layer containing a Ruthenium catalyst over the coupling agent, and depositing a second layer including a metal over the first layer using the Ruthenium catalyst as a nucleating agent.

### FIELD

The present invention relates in at least some of its embodiments to processes for forming electronic circuit components.

### BACKGROUND

Electroplating has been used to form interconnect and other structures on semiconductor substrates. For many integrated circuit applications, electroplating is no longer a viable option because of the large voltage drops that occur across the wafer. Electroplating also fails to produce optimal uniformity across the wafer and its deposition rate is often difficult to control.

Other metal deposition techniques have been developed as alternatives to electroplating. One technique, known as electroless (EL) plating, involves depositing metal on substrates using chemical rather than electrical means. In order for this technique to work, the substrate must first be coated with an activation layer. Then, a chemical process is performed which allows for the subsequent formation of metal using the activation layer. Current EL methods use a palladium film to form the activation layer. Palladium, however, has proven to be undesirable principally because of availability constraints and high-cost fluctuations.

### BRIEF DESCRIPTION OF THE DRAWINGS

FIGS. 1(a)-1(f) are diagrams showing different stages of a process for forming metal on a substrate in accordance with one embodiment of the present invention.

FIG. 2 is a flow chart including functional blocks that may be used to perform the stages of the process of FIG. 1.

FIG. 3 shows a coupling structure in accordance with one embodiment of the invention.

FIG. 4 is a diagram showing a system which may have one or more circuit components formed from a metal structure resulting from the process embodiments disclosed herein.

### DETAILED DESCRIPTION OF EMBODIMENTS

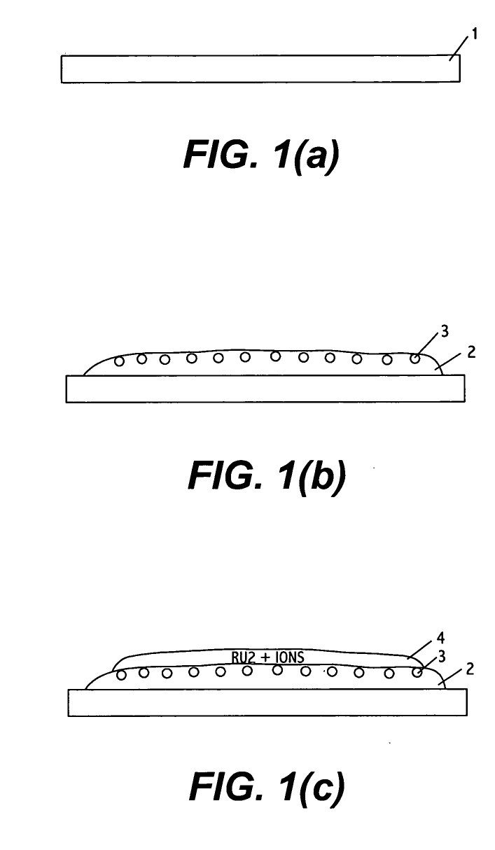

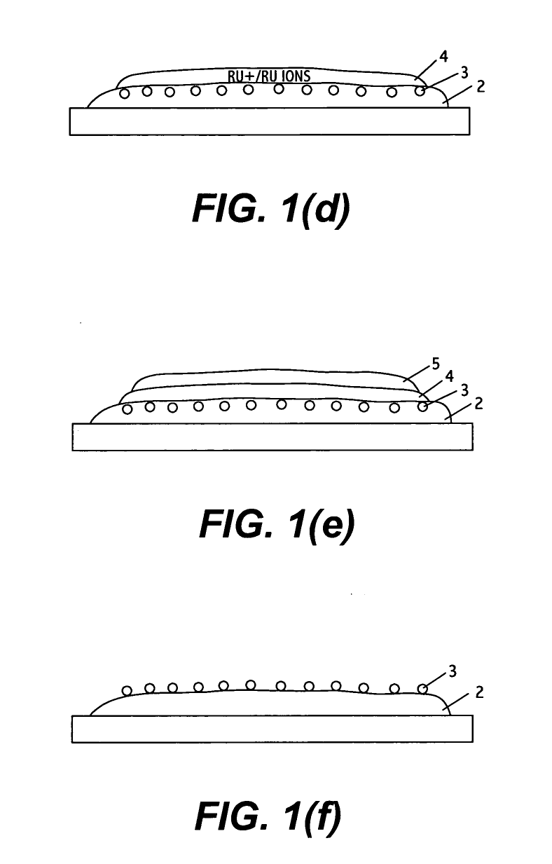

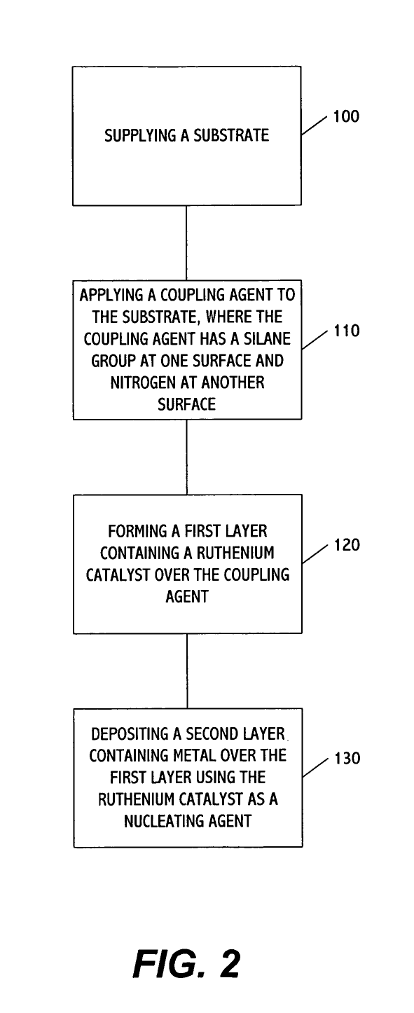

FIGS. 1(a)-1(f) show different stages of a process for forming metal on a substrate in accordance with one embodiment of the present invention, and FIG. 2 shows functional blocks that may be included in that process. For ease of explanation, these figures will be referred to simultaneously in the following discussion.

The process includes obtaining a substrate 1 for supporting one or more metal layers that will form, for example, a component of a circuit. (FIG. 1(a), Block 100). The substrate may be a conductive or non-conductive substrate made, for example, from tantalum (Ta) or various elements formed from tantalum including but not limited to TaNxₓ, TaCₓ, and TaRuₓ, tungsten (W) or various elements formed from tungsten including but not limited to WNₓ, and WRuₓ, titanium or various elements formed from titanium (Ti) including but not limited to TiNₓ, silicon (Si) or various elements formed from silicon including SiO₂, platinum (Pt), iridium (Ir), or a combination of two or more of these elements.

Next, a coupling agent 2 is applied to the substrate. (FIG. 1(b), Block 110). The coupling agent may include one or more Silane groups, which may prove beneficial for some applications because of their ability to bond strongly with almost any type of substrate, thereby lending flexibility to the process. The coupling agent may be applied using any one of a variety of techniques including but not limited to wet or dry chemical vapor deposition (CVD).

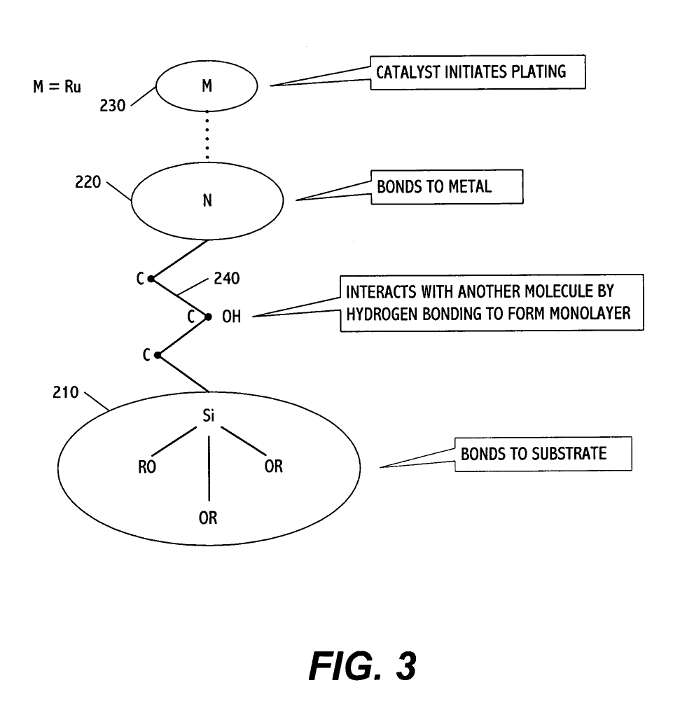

According to one arrangement, one end or surface of the coupling agent may include the Silane group and another end or surface may include a nitrogen group. The end or surface containing the Silane group may be adjacent the substrate, and the nitrogen group may be located on an opposing end or surface. Atoms in the nitrogen group are illustratively shown by reference numeral 3, and an exemplary structure of the coupling agent is shown in FIG. 3, which is discussed in greater detail below. FIG. 1(b) shows the nitrogen atoms within and along a top surface of the coupling agent 2. As an alternative, the nitrogen atoms may be exposed along the top surface of the coupling agent as shown in FIG. 1(f).

In forming the coupling agent, the Silane group may be exposed to (e.g., by immersion or spraying) an organic solution containing the nitrogen atoms. The nitrogen atoms may be included, for example, in molecules derived from an amine or azo group (which corresponds to a bivalent group -N=N- united to two aromatic groups). Such a group may be or include Azo-Benzene. The interaction of the organic solution may result in the formation of a nitrogen-containing monolayer along a surface or end of the coupling agent.

Next, a layer 4 containing a Ruthenium catalyst is formed over the layer containing the atoms in the nitrogen group. (Block 120). This may be accomplished, for example, by immersing (or dipping) the end of the coupling agent containing the nitrogen atoms in a solution containing Ruthenium ions. This will result in the formation of a layer of these ions (e.g., Ru2+) over the nitrogen. See FIG. 1(c). The Ru2+ ions are then exposed to a reducing agent, which at least partially reduces the Ru2+ ions to Ru+/Ru ions which correspond to the Ruthenium catalyst. See FIG. 1(d). When reduced in this manner, the substrate may be said to be in an activated state.

Exposure to the reducing agent may be performed by dipping or spraying the Ru2+ ion layer with an activator solution containing the reducing agent. Also, in forming the Ruthenium catalyst, the Ruthenium ions and the coupling agent may be located in separate solutions, or the Ruthenium ions and the coupling agent may be in a same solution.

The Ruthenium catalyst is firmly held in place over the substrate by coordinate covalent bonds that form between the Ru+/Ru ions and the nitrogen in layer 2. The underlying nitrogen, therefore, acts as an immobilizing structure which holds the catalyst in place on the substrate. In addition to the foregoing technique, it is noted that the immobilizing Ruthenium layer may be deposited by any one of a number of wet or dry chemical vapor deposition techniques.

Once the Ruthenium catalyst has been formed, the coupling agent may be said to be complexed with the catalyst. A metal layer 5 is then deposited using the Ruthenium catalyst as a nucleating agent, e.g., the Ruthenium catalyst acts as a nucleating site for deposition of the metal layer. (FIG. 1(e), Block 130). The metal layer may be formed using a variety of deposition techniques including but not limited to electroless (EL) deposition, as well as other forms of electrochemical deposition. If EL deposition is used, layer 4 containing the Ruthenium catalyst may serve as the activation layer, and the deposited metal may be any one of a variety of metals including but not limited to copper, cobalt, nickel, gold, silver, tin, zinc or a combination of these.

Copper may prove beneficial for some applications because this metal has an underpotential deposition on Ruthenium, which allows copper to be very easily deposited on Ruthenium. That is, copper more easily deposits on Ruthenium than on certain other metals including itself. This is because the deposition of copper on Ruthenium occurs at a lower potential than on other metals. This depolarization effect is sometimes referred to as underpotential deposition.

The foregoing process may be modified in a number of ways. For example, the coupling agent may be complexed with Ruthenium, first, by dipping the substrate into a solution containing Silane group molecules and then performing a spin coating process to ensure that the solution is evenly spread to an intended thickness. This may be followed by vapor deposition of the Ruthenium catalyst onto the coupling agent.

Another method involves spraying the catalyst onto the nitrogen-containing layer to thereby complex the coupling agent with Ruthenium. That is, the coupling agent is sprayed onto the substrate and the Ruthenium is deposited by a vapor deposition technique. Each coupling agent molecule has a Silane group at one end that bonds to the substrate and a nitrogen group at the other end to which the Ruthenium bonds.

Another method involves a dry process where a Silane coupling agent complexed with Ruthenium is evaporated onto a substrate surface. According to another method, a Silane agent may first be evaporated on the substrate, followed by a process of evaporating Ruthenium onto the Silane agent.

One or more embodiments of the process of the present invention maybe used in direct electroplating of conductive or non-conductive substrates with metal layers. These layers may be used, for example, as interconnects connecting electrical circuits on or off a chip die. Another example involves using the process to help perform plating on plastics for serving architectural or decorative purposes. Another use may be in the formation of micro-electromechanical systems (MEMS), a technology that combines computers with tiny mechanical devices such as sensors, valves, gears, mirrors, and actuators embedded in semiconductor chips. Other uses are also possible.

FIG. 3 shows a coupling structure in accordance with one embodiment of the present invention, which may be made, for example, using any of the processes discussed herein. The coupling structure includes a coupling agent 210, a nitrogen-containing layer 220, and a Ruthenium catalyst 230. The coupling agent may be formed from a Silane group. This group may include a silicon atom having three electrons bonded to three alkoxy groups (OR) respectively, where O represents an oxygen atom and R represents a litigating group. The remaining electron of the silicon atom is bonded to a carbon chain 240. In this example, the chain is formed from three carbon atoms (C), with one of the carbon atoms being bonded to an hydroxide (OH). In alternative embodiments, a carbon chain with a different number of carbon atoms may be used. The carbon chain serves to bond the coupling agent formed by the Silane group to the nitrogen-containing layer.

The nitrogen-containing layer may correspond to the monolayer discussed above, which is formed from an amine or azo group (lone pair on nitrogen) such as Azo-Benzene.

The Ruthenium catalyst may be an activated metal which includes Ru+/Ru ions. These ions are attracted to the azo group in the nitrogen-containing layer, which therefore acts to immobilize the catalyst onto the substrate through the formation of coordinate covalent bonds between the Ru+/Ru and the nitrogen. The immobilized Ruthenium catalyst may act as a nucleating agent for the formation of metal through, for example, an electroless deposition process. Put differently, the Ruthenium catalyst acts as a nucleation site where metal forms during EL deposition. This metal may be, for example, copper, cobalt, or any of the other metals previously mentioned in relation to Block 130.

Using Ruthenium as the catalyst in the foregoing embodiments is cheaper than other materials (e.g., palladium) that have been used as catalysts in other processes. Ruthenium also does not suffer from the cost pressures that these other materials routinely experience. Particularly, using Ruthenium as an activation layer during the electroless plating of metal onto conductive or non-conductive substrates will enable circuit designers to use more available material with better or equal catalyst properties as compared to these other materials.

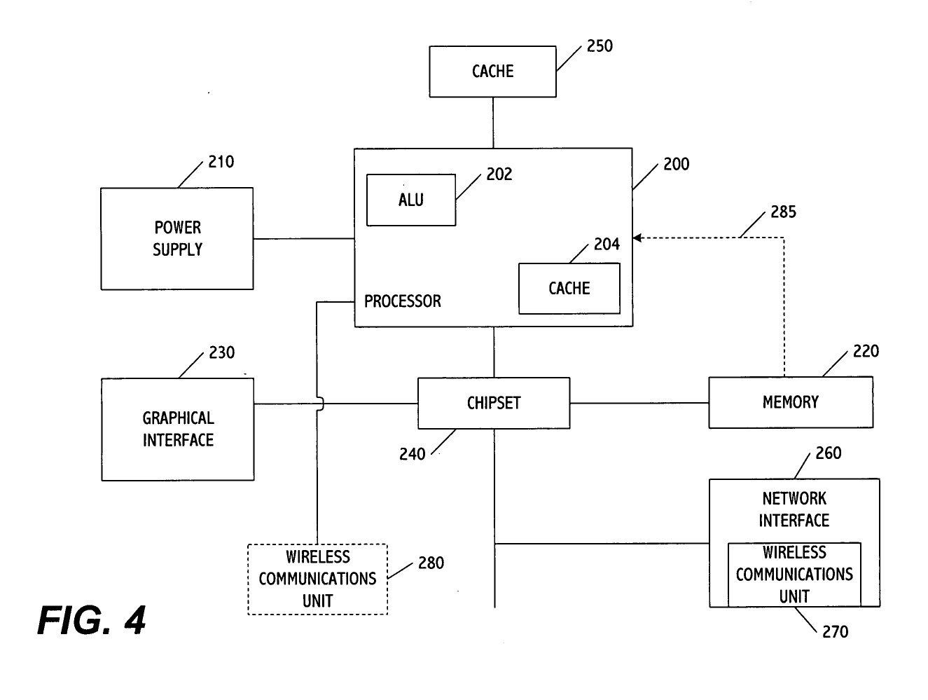

FIG. 4 shows a system which includes a processor 200, a power supply 210, and a memory 220 which, for example, may be a random-access memory. The processor includes an arithmetic logic unit 202 and an internal cache 204. The system also preferably includes a graphical interface 230, a chipset 240, a cache 250, a network interface 260, and a wireless communications unit 270, which may be incorporated within the network interface. Alternatively, or additionally, the communications unit 280 may be coupled to the processor, and a direct connection 285 may exist between memory 220 and the processor as well. This connection and the connections between and among the other blocks of the system may be formed by metal interconnect structures resulting from one or more of the processes described herein.

The processor may be a microprocessor or any other type of processor, and may be included on a chip die with all or any combination of the remaining features, or one or more of the remaining features may be electrically coupled to the microprocessor die through known connections and interfaces. Also, the connections that are shown are merely illustrative, as other connections between or among the elements depicted may exist depending, for example, on chip platform, functionality, or application requirements.

Any reference in this specification to an “embodiment” means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Furthermore, for ease of understanding, certain functional blocks may have been delineated as separate blocks; however, these separately delineated blocks should not necessarily be construed as being in the order in which they are discussed or otherwise presented herein. For example, some blocks may be able to be performed in an alternative ordering, simultaneously, etc.

Although the present invention has been described herein with reference to a number of illustrative embodiments, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

We claim:

1. A process, comprising:
forming a coupling agent with nitrogen on a substrate;
forming a first layer containing a Ruthenium catalyst over the coupling agent; and
depositing a second layer including a metal over the first layer using the Ruthenium catalyst as a nucleating agent.

2. The process of claim 1, wherein the coupling agent includes a Silane group of elements which bonds to the substrate.

3. The process of claim 2, wherein the Siliane group of elements is at a first end of the coupling agent adjacent the substrate and the nitrogen is at a second end of the coupling agent adjacent the first layer.

4. The process of claim 1, wherein the nitrogen in the coupling agent is included in an azo group.

5. The process of claim 1, wherein forming the first layer includes:
immersing the coupling agent with nitrogen in a solution containing Ruthenium ions; and
exposing a layer of Ruthenium ions formed on the coupling agent as a result of said immersing to a reducing agent, which at least partially reduces the Ruthenium ions to form the Ruthenium catalyst.

6. The process of claim 5, wherein the Ruthenium ions are Ru2+ ions and the Ruthenium catalyst includes Ru+/Ru.

7. The process of claim 1, wherein a coordinate covalent bond is formed between the nitrogen in the coupling agent and the Ruthenium catalyst in the first layer.

8. The process of claim 1, wherein depositing the second layer includes:
forming the second layer over the first layer using an electroless deposition process, in which the Ruthenium catalyst acts as a nucleating agent.

9. The process of claim 1, wherein the metal in the second layer includes copper.

10. A process, comprising:
forming an activation layer on a substrate; and
forming a metal layer over the activation layer, the activation layer including a Ruthenium catalyst which serves as a nucleating agent to initiate formation of the metal layer over the substrate.

11. The process of claim 10, wherein forming the activation layer includes:
bonding the activation layer to the substrate using a coupling agent having a Silane group at a first end and nitrogen at a second end.

12. The process of claim 11, wherein the Silane group is adjacent the substrate and the nitrogen is adjacent the activation layer.

13. A coupling structure, comprising:
a coupling agent;
a molecule from an azo group along a surface of the coupling agent; and
a Ruthenium catalyst adjacent the azo group along the surface of the coupling agent, said catalyst serving as a nucleating agent for initiating formation of a metal layer.

14. The coupling structure of claim 13, wherein the coupling agent includes one or more molecules from a Silane group, the one or more Silane group molecules located along another surface of the coupling agent.

15. The coupling structure of claim 13, wherein the molecule from the azo group includes nitrogen.

16. A method, comprising:
forming a metal layer on a substrate using a Ruthenium catalyst as a nucleating agent.

17. The method of claim 16, wherein the Ruthenium catalyst is complexed with molecules from a Silane group.

18. A system, comprising:
a first circuit; and
an interconnect coupling the first circuit to a second circuit,
wherein the interconnect includes a metal layer attached to a substrate by a coupling structure, the coupling structure including:
(a) a coupling agent;
(b) a molecule from an azo group along a surface of the coupling agent; and
(c) a Ruthenium catalyst adjacent the azo group along the surface of the coupling agent, said catalyst serving as a nucleating agent for initiating formation of a metal layer.

19. The system of claim 18, wherein the first and second circuits are located on a same chip die.

20. The system of claim 18, wherein the first circuit is located on a chip die and the second circuit is an off-die component.
